(19) United States
(12) Patent Application Publication
(10) Pub. No.: US 2020/0123901 A1
(43) Pub. Date: Apr. 23, 2020

(54) SIX-STROKE ROTARY-VANE INTERNAL COMBUSTION ENGINE

(71) Applicant: Nickolay Mikhailovich KRIVKO, Kingisepp, Leningradskaya oblast (RU)

(72) Inventor: Nickolay Mikhailovich KRIVKO, Kingisepp, Leningradskaya oblast (RU)

(21) Appl. No.: 16/607,506

(22) PCT Filed: Jun. 28, 2018
(86) PCT No.: PCT/RU2018/000425

§ 371 Date: Oct. 23, 2019

(30) Foreign Application Priority Data
Jul. 13, 2017 (RU) 2017124969

(51) Int. Cl. F01C 1/344; F01C 21/08; F02B 75/02

(52) U.S. Cl. CPC F01C 1/344; F02B 75/021; F01C 21/0845

(57) ABSTRACT

The invention relates to the engines area, in particular to an internal combustion engine (ICE) which can be used on water, air and land transport vehicles. The six-stroke rotary-vane internal combustion engine comprising a stator with inlet and outlet ports, holes for spark plugs and the working chambers of air-fuel intake and compression, alternating with working chambers of expansion and removing of the combustion products; a cylindrical rotor rigidly fixed to a shaft and having longitudinal grooves in which vanes are placed, with combustion chambers made on the cylindrical surface of the rotor between the grooves; side walls; front and rear bearing shields the side walls of all working chambers of the engine and composite prismatic parts are placed in grooves made in the end surfaces of the rotor, the prismatic parts at their end surfaces are pressed by springs to the adjacent vanes and by their side edges are pressed against the side walls of the working chambers. The achieved effect consists in providing an engine with completely sealing of the working zone preventing as leaks of air-fluid mixture beyond the working zone as well as inter-chamber leaks.

This invention refers to the engine-building area, in particular, to internal combustion engines with rotating parts, more specifically to a rotary-vane internal combustion engine (ICE), which can be used on water, air and land transport vehicles and also as a stationary power plant.

The Wankel rotary ICE is well known, it has a triangular rotor (piston) with arc-shaped side face, rotating on the eccentric shaft, housing (stator) acting as a cylinder with working face made as epitrochoid. The rotor-to-stator kinematical connection is provided by means of gear wheel. The end and radial seals are arranged in the form of spring-loaded plates located in the appropriate grooves on the rotor end surfaces and on the corners of its triangle (GSE, Soviet encyclopedia, 1971, volume 4, pages 289-290) (1). 3 full motion cycles occur per one rotor revolution, the eccentric shaft makes three revolutions.

The Wankel engine is notable for its simple design and has proven its efficiency in practical application. However, it has a number of significant disadvantages, the main ones of which include low adaptability to streamlined manufacture, unrepairability, unreliable end surface and radial seals and incomplete fuel combustion due to the non-optimal shape of its combustion chamber.

There is a rotary ICE under the RF patent for invention No. 2416032 (published on Nov. 10, 2010) (2). This engine has a housing (stator) with elliptic working face, a cylindrical rotor with vanes fitted in its longitudinal grooves, the pulleys fitted on these vanes displace them in radial direction, the pulleys roll over within the shaped grooves made in the side walls of the stator. The end surface and radial seals are flat-topped plates fitted in the vane grooves and spring-loaded rings located in the side wall bores. The four-stroke cycle occurs in each working chamber of the engine (2) per one full revolution of the rotor with shaft, which means that the number of working strokes per one revolution of the shaft and is determined by the number of working chambers that may vary from six to twenty-four.

This engine according to the patent (2) repeats the Wankel engine's major drawbacks, in particular, low adaptability to manufacture, unreliability of seals and non-optimality of its combustion chamber. In addition, this engine is quite large in size.

There is also known a six-stroke rotary-vane internal combustion engine (patent RF for invention No. 2619672 (published on May 17, 2017) (3). Said engine has a stator featuring inlet and outlet ports, ignition plug holes, air-fuel intake and compression chambers alternating with the combustion product expansion and removal working chambers; a cylindrical rotor rigidly fixed to the shaft and having longitudinal grooves in which vanes are placed, with combustion chambers arranged on the cylindrical surface of the rotor between the grooves; the side walls and the front and rear bearing shields.

The known engine provides a reliable solution to a problem of sealing between the rotor and the side walls of the working chambers as well as to a problem of gas leaks beyond the working zone. However, the sealing system does not exclude some inter-chamber leak of air-fluid mixture or exhaust combustion gases.

The task of this invention is to provide an engine with full sealing of the working zone preventing as leaks of air-fluid mixture beyond the working zone as well as inter-chamber leaks.

The task is to be resolved as follows the six-stroke rotary-vane ICE featuring a stator with inlet and outlet ports, with ignition plug holes, with air-fuel intake and compression working chambers alternating with the combustion product expansion and removal working chambers; the cylindrical rotor fixed to the shaft with longitudinal grooves in which the vanes are places, with combustion chambers arranged on the cylindrical surface of the rotor between the grooves, the side walls and the front and rear bearing shields, the side walls of all the working chambers of the engine are formed by parts attached to the stator in a rigid and sealed manner, the grooves made at the ends of the rotor comprise composite prismatic parts, the end surfaces of the prismatic parts are pressed by springs against the adjacent vanes and their side edges are pressed against the side walls of the working chambers.

Thus, said prismatic parts are spring-loaded in two directions sealing elements which allow preventing inter-chamber leak of gases through a gap between the rotor and the side wall.

Preferably, combustion chambers are arranged in the form of semispherical recesses [symbol] , [symbol] [symbol] potopa, working chambers of the stator are formed as cylindrical borings with the axes parallel to the stator axis and spaced evenly all over its internal surface, each vane consists of separate plates with possible free mutual displacement, in this case each vane plate is made of two parts being pulled apart by a spring in axial direction and the number of vanes is divisible by the number of air-fuel mixture intake chambers.

It should be noted that according to this invention the working surfaces of the engine major parts are to be treated using elementary motion machines—rotary and straight line onward machines, which provides adaptability to streamlined manufacture of this engine. Thus, according to this invention the rotary-vane ICE implements the six-stroke cycle consisting of the following strokes: air-fuel mixture injection, air-fuel mixture compression, air-fuel mixture combustion, expansion of combustion products, discharge of combustion products and cleaning, in this case the combustion process is separated from the compression and expansion in time and space. The sixth stroke—cleaning—prevents the mutual air-fuel mixture leaks into the exhaust gas discharge zone and the exhaust gases into the air-fuel mixture intake zone. The number of double (triple, quadruple, etc) strokes per one shaft revolution is equal to the number of vanes within the rotor grooves. The invention also makes it possible to switch the ICE to economical run, in this case the number of working stokes per one rotor revolution will remain the same.

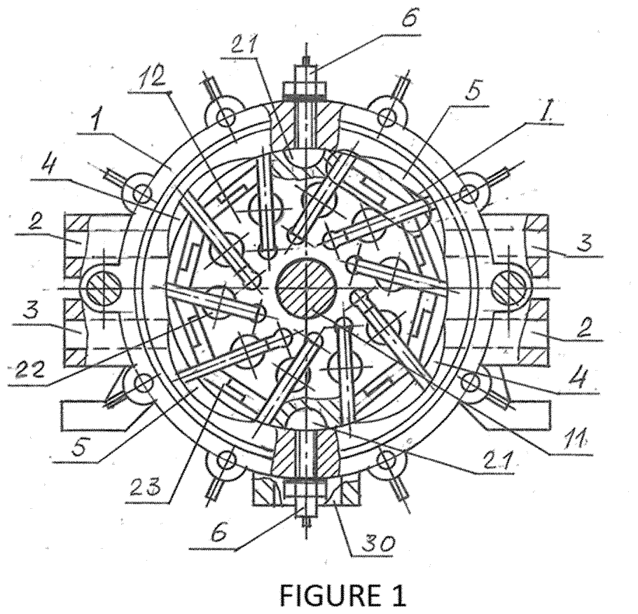

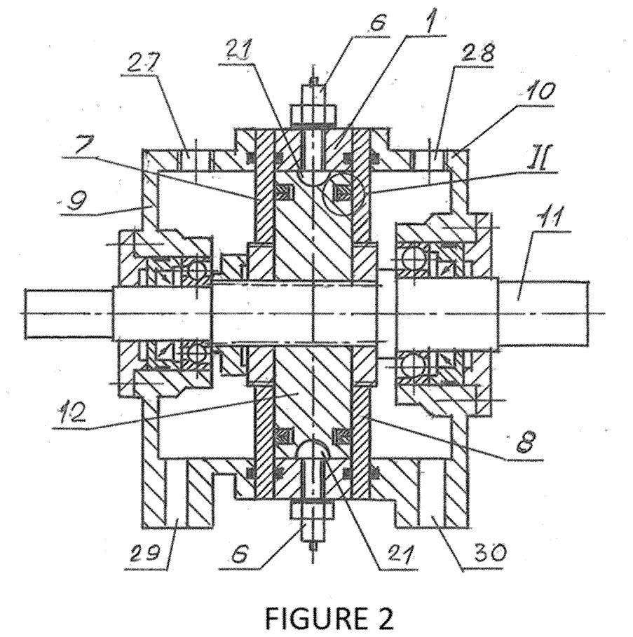

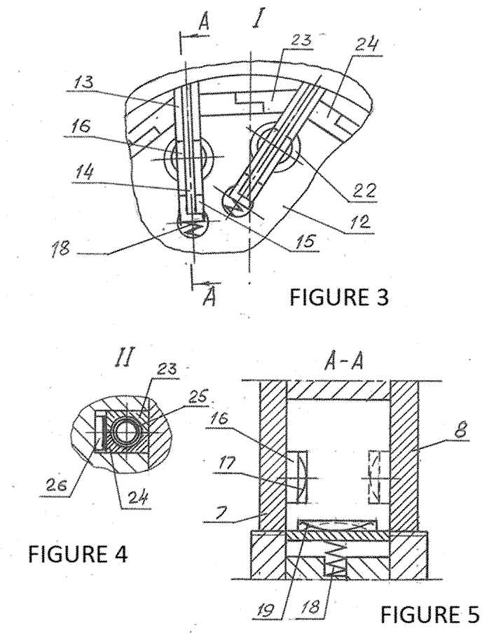

The essence of this invention is explained by drawings, where FIG. 1 illustrates the engine in cross-sectional view; FIG. 2 illustrates axial cross-section of the engine from FIG. 1; FIG. 3 illustrates point I from FIG. 1; FIG. 4 illustrates point II from FIG. 2; FIG. 5 illustrates cross-section A-A from 3.

The rotary-vane ICE has stator 1 (FIG. 1; 2) with inlet 2 and outlet 3 ports (FIG. 1). Along the inner cylindrical surface of stator 1 there are cylindrical bores forming by pairs air-fuel intake mixture chambers 4 and combustion product expansion chambers 5 (FIG. 1). Plugs 6 are screwed into the threaded holes of stator 1 (FIG. 1; 2). The side walls 7 and 8 (FIG. 2; 5) are centered and rigidly attached to stator 1 (FIG. 2). The front 9 and rear 10 bearing shields are centered and rigidly attached to stator 1 (FIG. 2). In the shields 9 and 10 shaft 11 is mounted on the radial-thrust bearings, whereon the rotor 12 is rigidly fastened (FIG. 1; 2; 3). There are plates 13, 14, 15 with spacers 16 fitted in the longitudinal grooves of rotor 12 (FIG. 3; 5). The quantity of the plates may be random, but no less than two. Spacers 16 and plates 13, 14, 15 come loose by springs 17 (FIG. 5). Under the plates 13, 14, 15 springs 18 are placed (common for all plates of the vane) (FIG. 3; 5), under the plates 14, 15 springs 19 are placed (separate spring for each vane) (FIG. 5). Semispherical recesses 21 are made over the cylindrical surface of rotor 12 between the longitudinal grooves (FIG. 1; 2). Spring-loaded oil removers 22 (FIG. 1; 3) are fitted in the bores made in rotor 12. In the grooves formed in the end surfaces of the rotor 12 (point II, ϕ [symbol] ) prismatic parts consisting of two halves 23 n 24 are placed (ϕ [symbol] ), the halves being pulled apart by spring 25 (FIG. 4) and pressed by spring 26 (FIG. 4) against side walls 7 and 8 (FIG. 2). In the upper part of the shields 9 and 10 holes 27 and 28 (FIG. 2) are made. In the lower side of shields 9 and 10 holes 29 and 30 are made (FIG. 1; 2).

Let us review the ICE operation according to the invention by an example given in FIG. 1 (with two intake chambers, clockwise rotation).

Each plate 13, 14, 15 is pressed by through spacer 16 against side walls 7 and 8 in a checkerboard manner. Each half 23 and 24 of the prismatic parts is pressed at its end surface by springs 25 to plates 13, 15 (in combination—vanes), and by springs 26—to side walls 7 and 8. The combination of the mentioned parts provides reliable sealing at the end surfaces. Once the engine has run the springs 18, 19 provide pressing the vanes to the working surface of the stator 1. During rotation of rotor 12, the air-fuel mixture is sucked into the space of air-fuel mixture intake chambers 4 through inlet ports 2, this air-fuel mixture then during further rotation is compressed by the next vane within the tapered space limited by the cylindrical surfaces of stator 1, rotor 12 and side walls 7 and 8.

At the final stage of compression the mixture is concentrated in semispherical recess 21 on the cylindrical surface of rotor 12. At this moment plugs 6 ignite the mixture, which then burns within the closed space before the front moving vanes starts extending into the opening space of combustion product expansion chamber 5 thus giving torque to shaft 11. During further rotation outlet ports 3 open up after the upstream vanes and exhaust gases are removed from chambers 5. The portion of central cylindrical surface of the stator between combustion product expansion and exhaust gas chambers 5 and air-fuel mixture intake and compression chambers 4 expels the exhaust gases and prevents the exhaust gases from entering into the air-fuel mixture intake zone. Through holes 27 and 28 lubricating and cooling substance is supplied (oil, oil fog), providing cooling of the working zone and lubricating the mating surfaces. Through holes 29 and 30 the substance is removed for regeneration and cooling. The synchronous movement of the vanes within the rotor grooves provides dynamic balance of the engine. Once the steady mode of the engine is reached the air-fuel mixture supply of fuel to one (or more) of air-fuel intake and compression chambers and the compression fuel-air mixture can be halted by any known method provided that the air supply to the given chamber is maintained. In this case, the engine continues to operate with reduced power output with the same number of working strokes maintained per one rotor revolution.

1. A six-stroke rotary-vane internal combustion engine comprising a stator with inlet and outlet ports, holes for spark plugs and the working chambers of air-fuel intake and compression, alternating with working chambers of expansion and removing of the combustion products; a cylindrical rotor rigidly fixed to a shaft and having longitudinal grooves in which vanes are placed, with combustion chambers made on the cylindrical surface of the rotor between the grooves; side walls; front and rear bearing shields, characterized in that the side walls of all working chambers of the engine are formed as parts which are rigidly and hermetically fastened to the stator and in that composite prismatic parts are placed in grooves made in the end surfaces of the rotor, the prismatic parts at their end surfaces are pressed by springs against the adjacent vanes and at their side edge—against the side walls of the working chambers.

2. The engine of claim 1, characterized in that the combustion chambers are made in the form of semispherical recesses between longitudinal grooves of the rotor, the working chambers of the stator are made in the form of cylindrical borings with the axes being parallel to the stator axis and spaced evenly all over its internal surface, each vane consists of separate plates with possible free mutual displacement, each vane plate is made of two parts being pulled apart by a spring in axial direction and the number of vanes is divisible by the number of air-fuel mixture intake chambers.
